(19) United States
(12) Patent Application Publication
(10) Pub. No.: US 2016/0038881 A1
(43) Pub. Date: Feb. 11, 2016

(54) TUBE ASSEMBLY FOR A REVERSE OSMOSIS FILTER CARTRIDGE

(71) Applicants: Wei-Cheng Yang, Pingtung County (TW); Wei-Li Yang, Pingtung County (TW)

(72) Inventors: Wei-Cheng Yang, Pingtung County (TW); Wei-Li Yang, Pingtung County (TW)

(21) Appl. No.: 14/451,677

(22) Filed: Aug. 5, 2014

(51) Int. Cl. B01D 63/06; C02F 1/44

(52) U.S. Cl. CPC B01D 63/06; C02F 1/441

(57) ABSTRACT

A tube assembly for a reverse osmosis filter cartridge has a tube body, an inlet port, an outlet port, two side assemblies and a stop cone. Each of the side assemblies has a block ring, a bearing plate, a sealing plate and a connecting tube. The sealing plate has a clamping segment and at least one rotation-stopping segment formed on an inward surface of the sealing plate, and the stop cone is securely mounted around the clamping segment and engages with the at least one rotation-stopping segment, thereby securely assembling the stop cone and the sealing plate to avoid relative shake and rotation.

### BACKGROUND OF THE INVENTION

1. Field of the Invention

The present invention relates to a tube assembly for a reverse osmosis filter cartridge, especially to a tube assembly that includes a filament winding tube body and a particular assembly for sealing the inside solution and operating the filtration process.

2. Description of the Prior Arts

A conventional tube assembly for a reverse osmosis filter cartridge has a filament winding tube body, an inlet port, an outlet port, two side assemblies and a stop cone. The tube body has an inner space and two openings. The openings are respectively formed on two sides of the tube body. The inlet port and the outlet port are mounted on an inner surface of the tube body, and protrude out of the tube body. The inlet port and the outlet port are respectively adjacent to the sides of the tube body. The side assemblies are mounted in the tube body, and are respectively adjacent to the openings of the tube body. Each side assembly seals the opening, and has a channel communicating with the inner space of the tube body and an exterior environment. The stop cone is hollow and is mounted on the side assembly that is adjacent to the outlet port.

When the tube assembly for a reverse osmosis filter cartridge is in use, the filter cartridge is mounted in the tube body, and connects two side assemblies. A side plug is mounted in the side assembly that is adjacent to the inlet port to seal the channel of the side assembly. Solution flows into the tube body from the inlet port, passes through the filter cartridge, and then is divided into waste fluid and filtrate. The waste fluid flows out of the outlet port, and the filtrate flows out of the channel of the side assembly that is adjacent to the outlet port.

The conventional tube assembly for a reverse osmosis filter cartridge has the following shortcomings.

First, each of the side assemblies has a block ring, a bearing plate, a sealing plate and a connecting tube. The block ring engages with an inner surface of the tube body. The bearing plate abuts outward on the block ring. The sealing plate abuts outward on the bearing plate, and has a tube segment. The tube segment is axially formed on a center of the sealing plate, is mounted through and protrudes out of the bearing plate. One of the two ends of the connecting tube is mounted in the tube segment of the sealing plate, and the other end of the connecting tube is mounted in the filter cartridge. The connecting tube and the tube segment form the channel of the side assembly to discharge the filtrate from the filter cartridge to be collected. When in use, the solution flow pushes the filter cartridge toward the side assembly that is adjacent to the outlet port, such that the stop cone is mounted on said side assembly to abut the filter cartridge. However, the conventional stop cone abuts the sealing plate only by one end of the stop cone, and has no further connection with the side assembly. Thus, the connection between the stop cone and the sealing plate is not secure, which easily causes shake when using. In addition, the structure of the conventional stop cone is not strong enough, either, such that the stop cone may be broken easily after long time of using.

Second, the sealing plate has a bearing flange formed on an outward surface of the sealing plate, and formed annularly around a periphery of the sealing plate. The sealing plate abuts the bearing plate only by the bearing flange, such that the abutting between the sealing plate and the bearing plate is not secure enough, which easily causes relative moving or rotating when strong solution flow pushes the side assembly.

Third, the conventional block ring is a strip wound spirally, and the tube body has two outer annular grooves formed in the inner surface of the tube body and being respectively adjacent to the openings of the tube body to accommodate the block ring. To mount the block ring, one of two ends of the block ring, which is originally a strip, is inserted into the outer annular groove, and the block ring is pushed along the outer annular groove. The block ring, which is wound spirally, axially overlaps itself to become a spiral gradually when moving along the outer annular groove. The pushing of the block ring is not stopped until the block ring is completely inserted into the outer annular groove. At this time, a portion, which protrudes out of the outer annular groove, of the block ring can abut the bearing plate. However, assembling and disassembling the block ring to and from the tube body takes much time and effort, and is inconvenient. Besides, the conventional block ring, which is a strip wound spirally, is not strong enough in structure and is easily bent and crooked when axially and forcefully pushed by the bearing plate, thereby reducing the safety in using.

To overcome the shortcomings, the present invention provides a tube assembly for a reverse osmosis filter cartridge to mitigate or obviate the aforementioned problems.

### SUMMARY OF THE INVENTION

The main objective of the present invention is to provide a tube assembly for a reverse osmosis filter cartridge that includes a filament winding tube body and a particular assembly for sealing the inside solution and operating the filtration process.

The tube assembly for a reverse osmosis filter cartridge has a tube body, an inlet port, an outlet port, two side assemblies and a stop cone. Each of the side assemblies has a block ring, a bearing plate, a sealing plate and a connecting tube. The sealing plate has a clamping segment and at least one rotation-stopping segment formed on an inward surface of the sealing plate, and the stop cone is securely mounted around the clamping segment and engages with the at least one rotation-stopping segment, thereby securely assembling the stop cone and the sealing plate to avoid relative shake and rotation.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a tube assembly for a reverse osmosis filter cartridge in accordance with the present invention;

FIG. 2 is a side view in partial section of the tube assembly for a reverse osmosis filter cartridge in FIG. 1;

FIG. 3 is an enlarged side view in partial section of the tube assembly for a reverse osmosis filter cartridge in FIG. 1, showing an outlet port;

FIG. 4 is an enlarged side view in partial section of the tube assembly for a reverse osmosis filter cartridge in FIG. 1, showing an inlet port;

FIG. 5 is an end view in partial section of the tube assembly for a reverse osmosis filter cartridge in FIG. 1, showing the outlet port;

FIG. 6 is an exploded perspective view of a side assembly of the tube assembly for a reverse osmosis filter cartridge in FIG. 1;

FIG. 7 is a perspective view of a block ring of the tube assembly for a reverse osmosis filter cartridge in FIG. 1;

FIG. 8 is an operational front view of the block ring of the tube assembly for a reverse osmosis filter cartridge in FIG. 1, showing the block ring in use;

FIG. 9 is an operation front view of the block ring of the tube assembly for a reverse osmosis filter cartridge in FIG. 1, showing the block ring not in use;

FIG. 10 is an end view of the tube assembly for a reverse osmosis filter cartridge in FIG. 1, showing the outlet port;

FIG. 11 is a perspective view of a bearing plate, a sealing plate and a stop cone of the tube assembly for a reverse osmosis filter cartridge in FIG. 1;

FIG. 12 is an end view of the sealing plate of the tube assembly for a reverse osmosis filter cartridge in FIG. 1;

FIG. 13 is an end view of a second embodiment of a tube assembly for a reverse osmosis filter cartridge in accordance with the present invention, showing the block ring in use;

FIG. 14 is a perspective view of the sealing plate of a third embodiment of a tube assembly for a reverse osmosis filter cartridge in accordance with the present invention;

FIG. 15 is a perspective view of the sealing plate of the tube assembly for a reverse osmosis filter cartridge in FIG. 14, showing the reserved hole annular flange;

FIG. 16 is a perspective view of the bearing plate of a fourth embodiment of a tube assembly for a reverse osmosis filter cartridge in accordance with the present invention;

FIG. 17 is an operational front view of the block ring of a fifth embodiment of a tube assembly for a reverse osmosis filter cartridge in accordance with the present invention, showing the block ring in use; and

FIG. 18 is an enlarged side view in partial section of a sixth embodiment of the tube assembly for a reverse osmosis filter cartridge in FIG. 1, showing an inlet port.

### DETAILED DESCRIPTION OF THE PREFERRED EMBODIMENTS

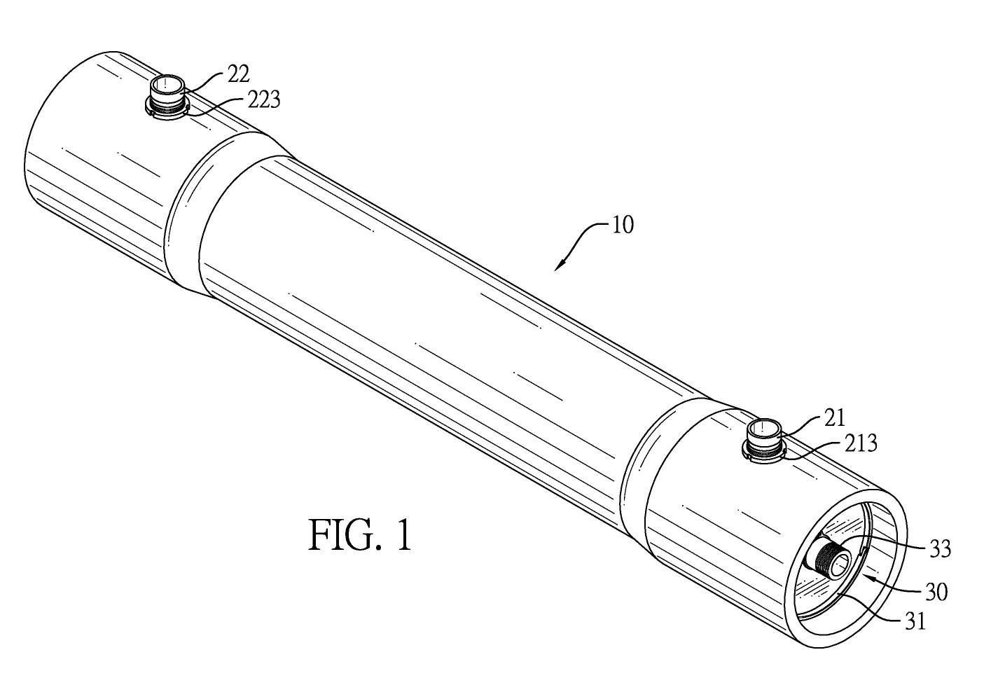

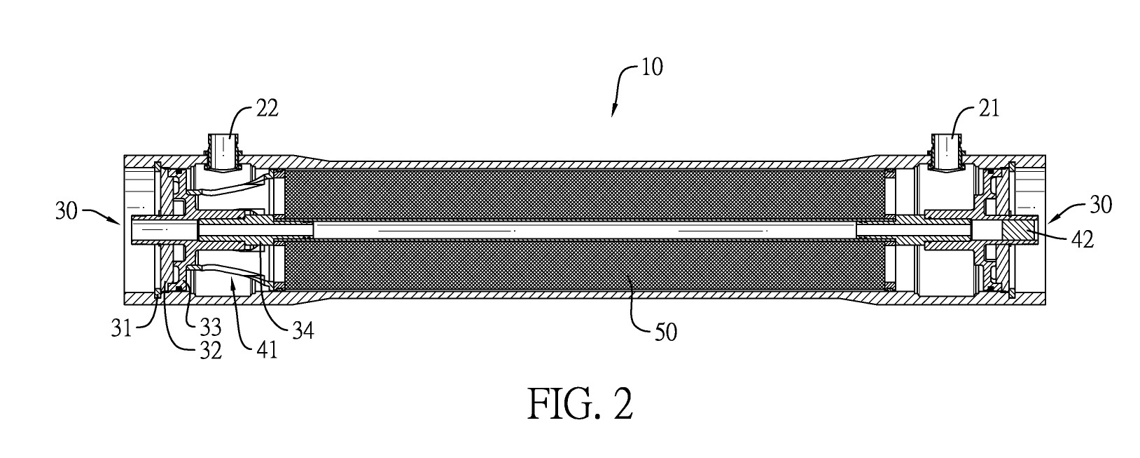

With reference to FIGS. 1 and 2, a first embodiment of a tube assembly for a reverse osmosis filter cartridge in accordance with the present invention comprises a tube body 10, an inlet port 21, an outlet port 22, two side assemblies 30 and a stop cone 41.

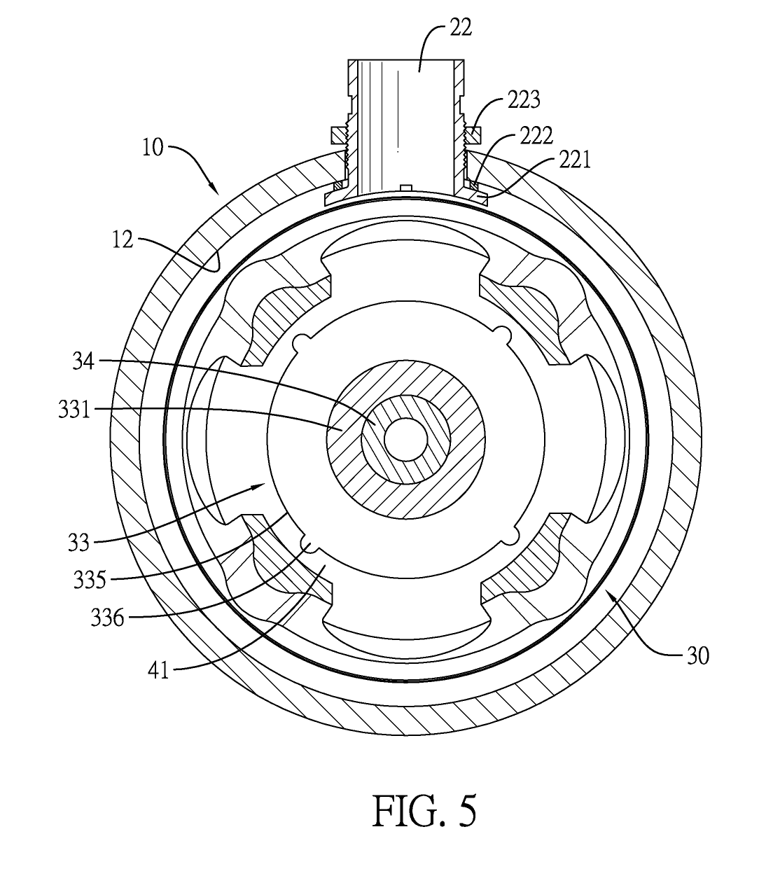

With reference to FIGS. 1 and 3 to 5, the tube body 10 has an inner space, two openings, two outer annular grooves 11, and two inner annular recesses 12. The openings are respectively formed on two sides of the tube body 10. The outer annular grooves 11 and the inner annular recesses 12 are formed in an inner surface of the tube body 10. The outer annular grooves 11 are respectively adjacent to the openings of the tube body 10. The inner annular recesses 12 are respectively adjacent to the openings of the tube body 10, and are respectively disposed in an axial inner side relative to the outer annular grooves 11. In a preferred embodiment, the tube body 10 is made of composite material with reinforced plastics. Preferably, the tube body 10 is wound by filament winding with material such as glass fiber, carbon fiber, Poly-paraphenylene terephthalamide (branded Kevlar) or basalt fiber.

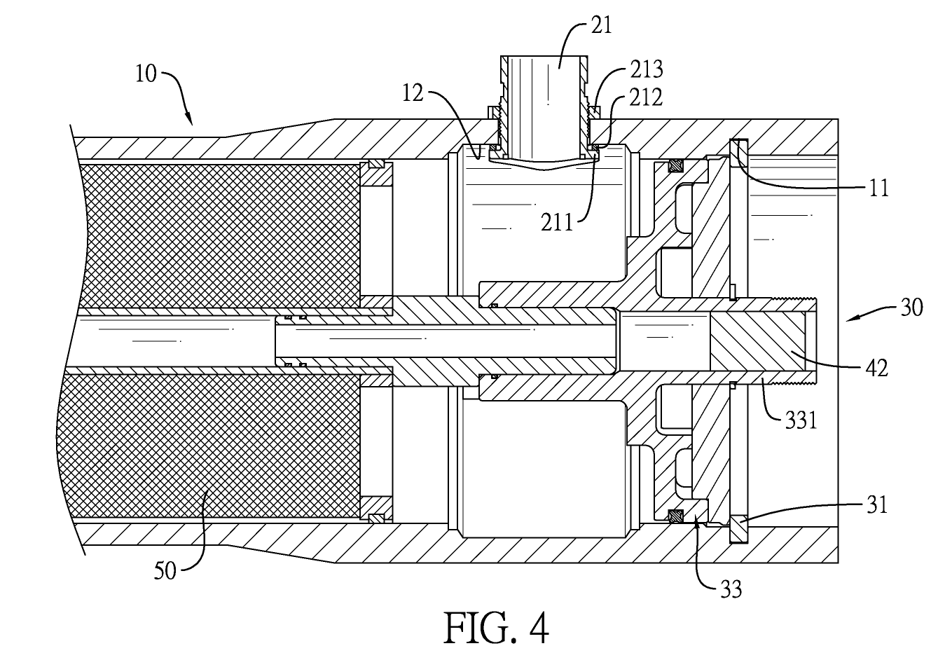

With reference to FIGS. 1 and 4, the inlet port 21 is mounted through one of the inner annular recesses 12, protrudes out of the tube body 10, and has an abutting flange 211. A radian of the abutting flange 211 corresponds to a radian of the inner annular recess 12. The abutting flange 211 is attached with a bottom of the inner annular recess 12. A seal ring 212 is clamped between the abutting flange 211 and the bottom of the inner annular recess 12. A nut 213 is screwed on an outer end of the inlet port 21, and abuts an outer surface of the tube body 10.

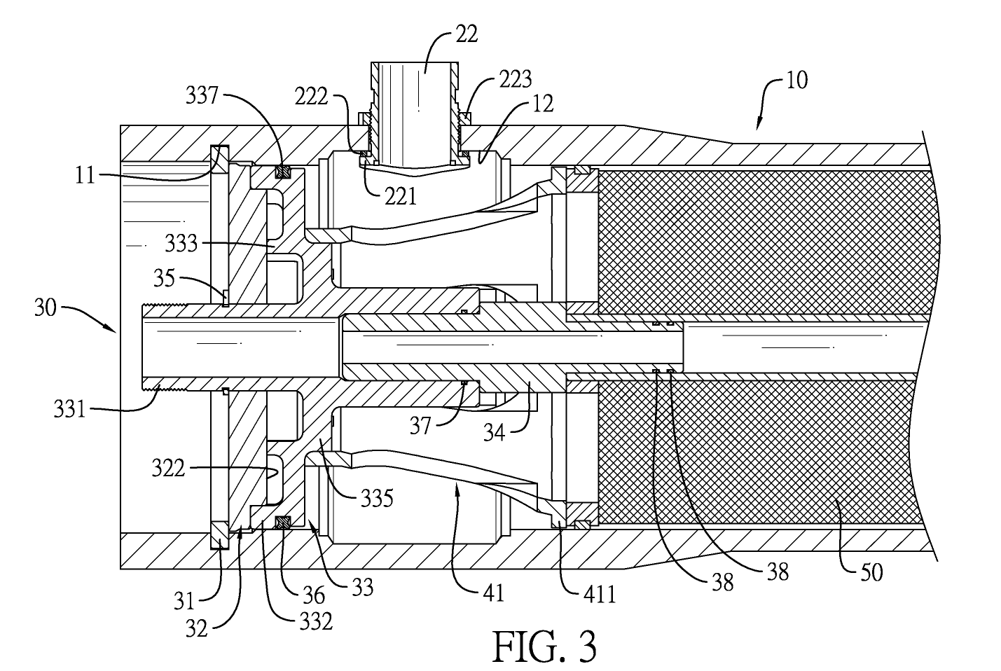

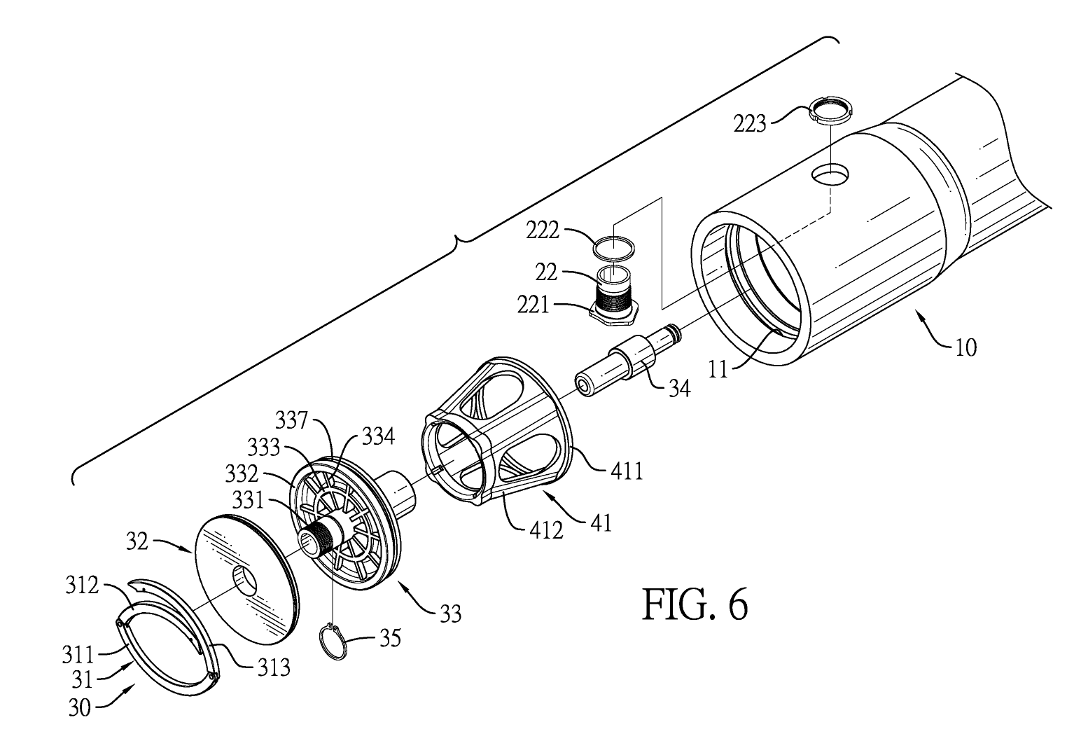

With reference to FIGS. 3, 5 and 6, the outlet port 22 is mounted through the other inner annular recess 12, protrudes out of the tube body 10, and has an abutting flange 221. A radian of the abutting flange 221 corresponds to the radian of the inner annular recess 12. The abutting flange 221 is attached with the bottom of the inner annular recess 12. A seal ring 222 is clamped between the abutting flange 221 and the bottom of the inner annular recess 12. A nut 223 is screwed on an outer end of the outlet port 22, and abuts the outer surface of the tube body 10.

With reference to FIGS. 2, 3 and 6, the side assemblies 30 are mounted in the tube body 10, and are respectively adjacent to the openings of the tube body 10. The side assemblies 30 seal the openings of the tube body 10, and each side assembly 30 has a channel communicating with the inner space of the tube body 10 and an exterior environment. In a preferred embodiment, each of the side assemblies 30 further has a block ring 31, a bearing plate 32, a sealing plate 33, a C-clip 35 and a connecting tube 34.

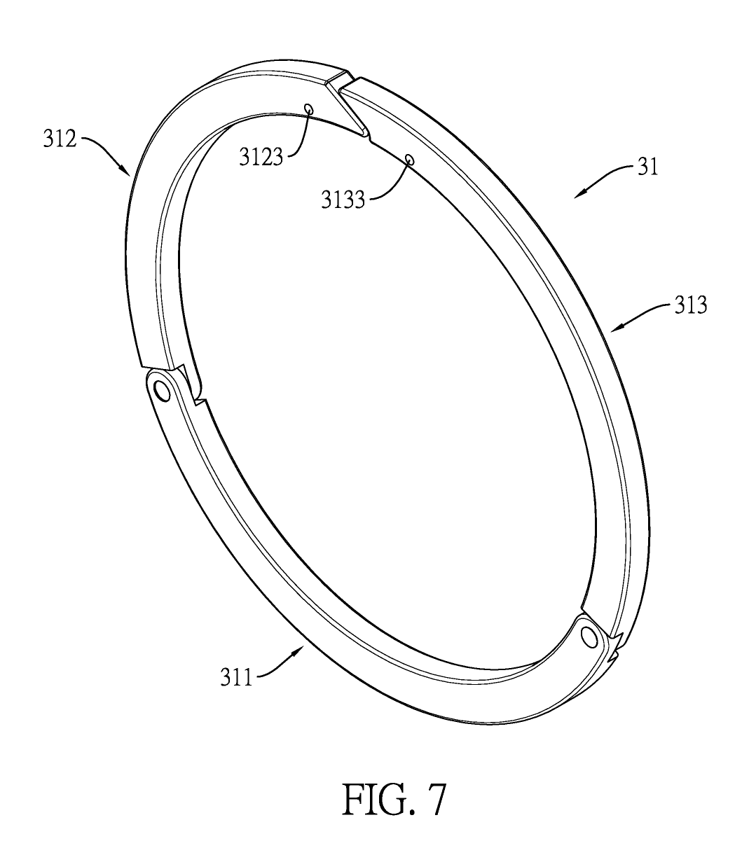

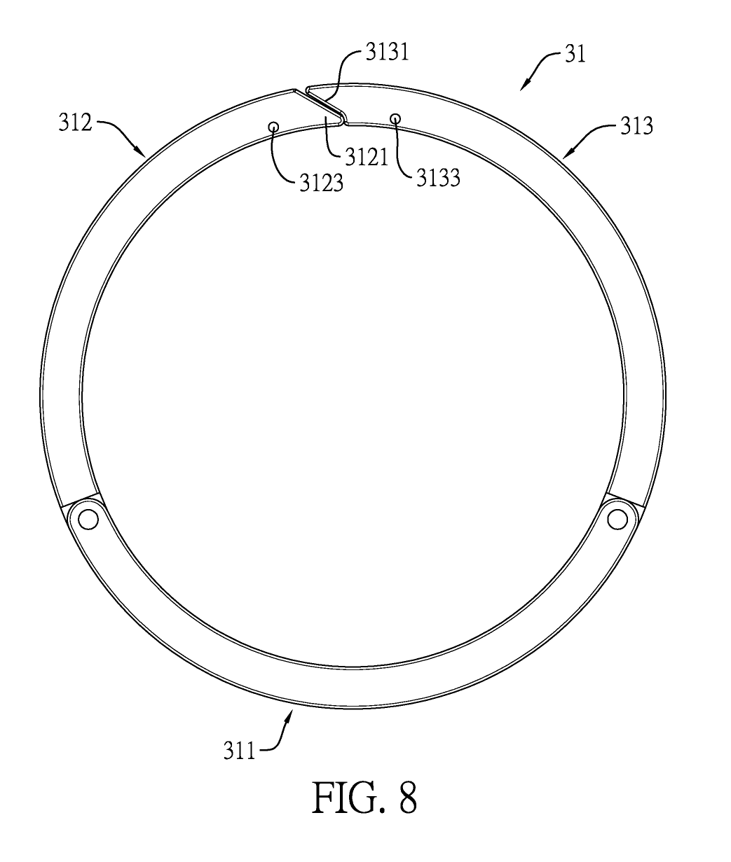

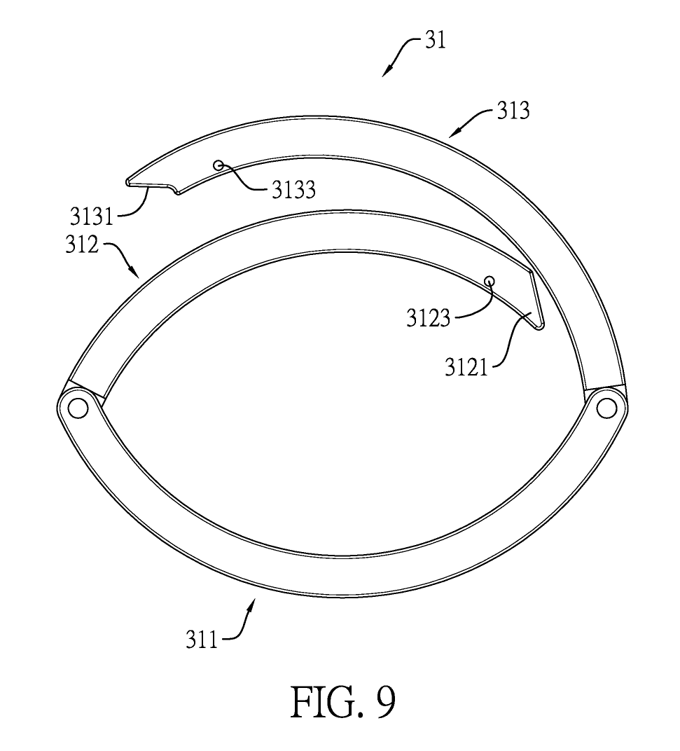

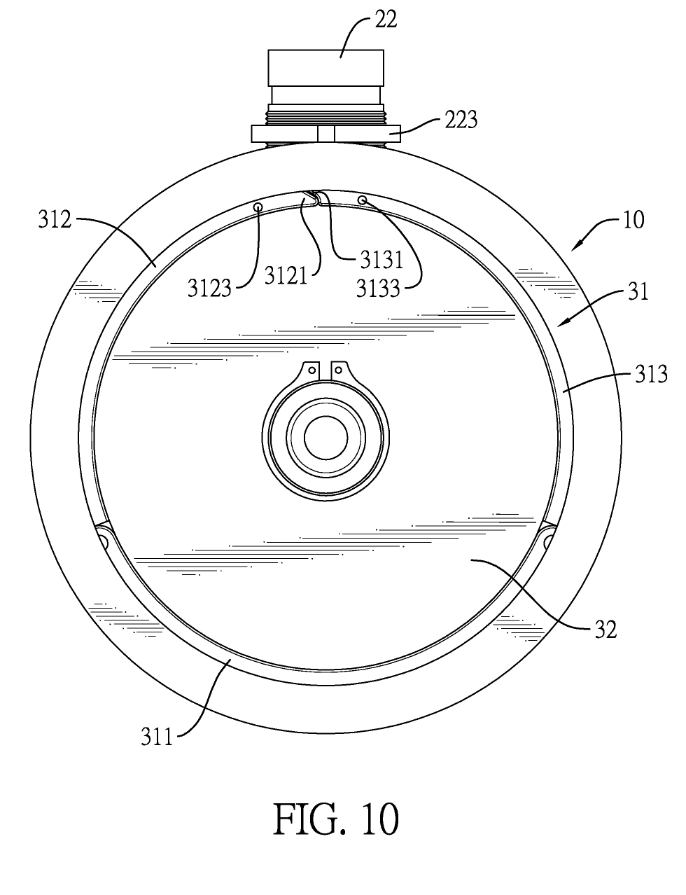

With reference to FIGS. 3 and 7 to 10, the block ring 31 engages with the corresponding outer annular groove 11 of the tube body 10. In a preferred embodiment, the block ring 31 has three block segments, which respectively are a first block segment 311, a second block segment 312 and a third block segment 313. Two ends of the first block segment 311 are respectively pivotally connected to an inner end of the second block segment 312 and an inner end the third block segment 313. An outer end of the second block segment 312 and an outer end of the third block segment 313 detachably abut each other. When the outer ends of the second block segment 312 and the third block segment 313 abut each other, the block segments 311, 312, 313 form a loop. The second block segment 312 has an abutting protrusion 3121. The abutting protrusion 3121 is formed on the outer end of the second block segment 312, and is inclined transversely and inwardly. The third block segment 313 has an abutting recess 3131. The abutting recess 3131 is formed on the outer end of the third block segment 313, and is inclined transversely and inwardly. When the outer ends of the second block segment 312 and the third block segment 313 abut each other, the abutting protrusion 3121 and the abutting recess 3131 abut each other. The second block segment 312 has a separating hole 3123. The separating hole 3123 is formed in the second block segment 312, and is disposed adjacent to the outer end of the second block segment 312. The third block segment 313 has a separating hole 3133. The separating hole 3133 is formed in the third block segment 313, and is disposed adjacent to the outer end of the third block segment 313.

With reference to FIGS. 3, 6, 9 and 10, when the block ring 31 is assembled on the tube body 10, the block segments 311, 312, 313 are rotatable relative to each other. For mounting the block ring 31 to the tube body 10, the block ring 31, which is not formed into a loop yet, is mounted into the outer annular groove 11, and then the second block segment 312 and the third block segment 313 are rotated to make the outer ends of the two block segments 312, 313 abut each other. Thus, the block segments 311, 312, 313 are braced transversely and outwardly to securely abut an inner surface of the outer annular groove 11. Therefore, the block ring 31 is securely mounted in the outer annular groove 11. Besides, when the outer ends of the second block segment 312 and the third block segment 313 abut each other, the abutting protrusion 3121 and the abutting recess 3131 abut each other, such that it is hard to separate the second block segment 312 and third block segment 313. To disassemble the block ring 31 from the tube body 10, a user just has to insert a pointed tool such as an awl into one of the separating holes 3123, 3133, and then push the pointed tool transversely and inwardly. At this time, the second block segment 312 and third block segment 313 do not abut each other, and the user can easily remove the block ring 31. Consequently, the block ring 31 is easily to be assembled and disassembled, and is mounted securely in the tube body 10 when assembled. In addition, the block ring 31 is not axially divided into multiple parts as the conventional block ring that is a strip wound spirally, and the block ring 31 is integrated axially, such that the block ring 31 can effectively and axially bear the outward abutting of the bearing plate 32, which prevents the block ring 31 from deformation and enhances the safety in using.

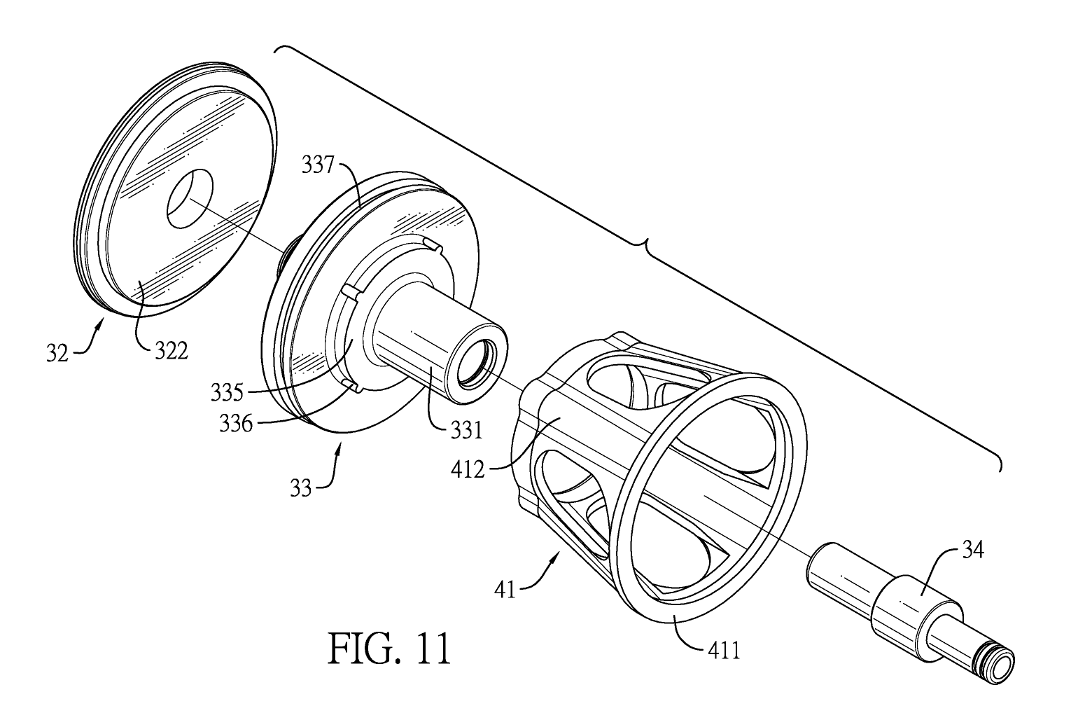

With reference to FIGS. 3, 6 and 11, the bearing plate 32 abuts outward on the block ring 31. The bearing plate 32 has a clamping segment 322. The clamping segment 322 is formed on an inward surface of the bearing plate 32, and is circular in axial cross section.

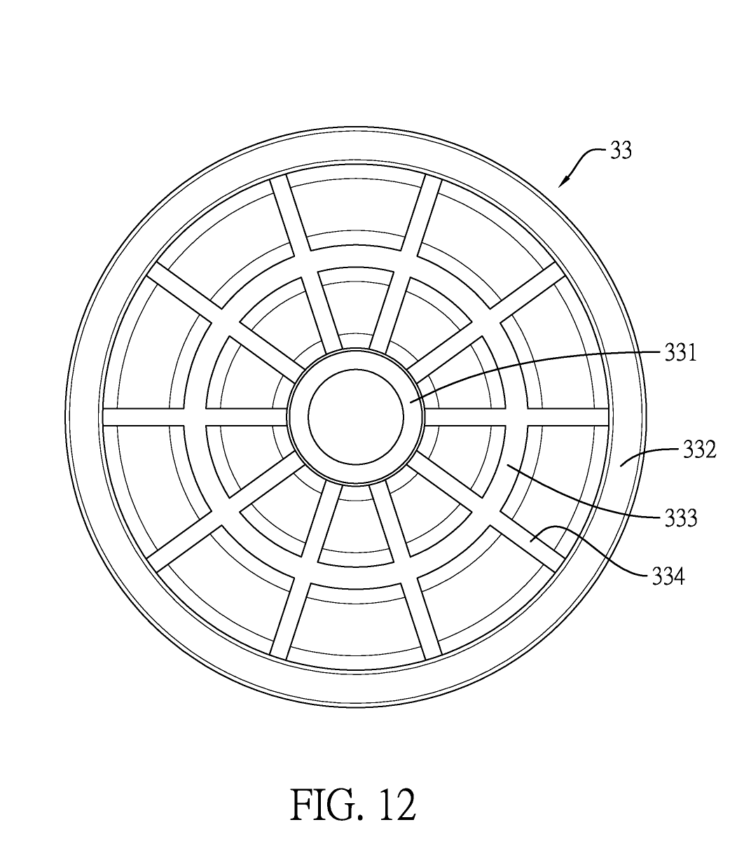

With reference to FIGS. 3, 6 and 10 to 12, the sealing plate 33 abuts outward on the bearing plate 32 and has a tube segment 331, a bearing flange 332, a seal ring groove 337, an annular rib 333, multiple transverse ribs 334, a clamping segment 335 and four rotation-stopping segments 336. The tube segment 331 is axially formed on a center of the sealing plate 33, is mounted through and protrudes out of the bearing plate 32. The bearing flange 332 is formed on an outward surface of the sealing plate 33, is formed annularly around a periphery of the sealing plate 33, abuts outward on the bearing plate 32, and is securely mounted around the clamping segment 322 of the bearing plate 32. Thus, the sealing plate 33 is mounted securely to the bearing plate 32. The seal ring groove 337 is formed annularly in the periphery of the sealing plate 33, and is adjacent to the bearing flange 332. An X-shaped seal ring 36 is mounted between the periphery of the sealing plate 33 and the inner surface of the tube body 10, and is mounted in the seal ring groove 337. The annular rib 333 and the transverse ribs 334 are formed on the outward surface of the sealing plate 33. The transverse ribs 334 extend transversely from the tube segment 331, connect to the annular rib 333 and the bearing flange 332, and are annularly arranged spaced apart from one another. The annular rib 333 and the transverse ribs 334 abut outward on the clamping segment 322 of the bearing plate 32. Thus, the sealing plate 33 securely abuts the bearing plate 32. The clamping segment 335 is formed on an inward surface of the sealing plate 33, and is formed annularly around the tube segment 331. The rotation-stopping segments 336 are formed transversely on the clamping segment 335, and are annularly arranged spaced apart from one another. In a preferred embodiment, each of the rotation-stopping segments 336 is, but not limited to, a protrusion, and connects to the inward surface of the sealing plate 33. Alternatively, each of the rotation-stopping segments 336 may be a recess.

With reference to FIGS. 3, 6 and 10, the C-clip 35 engages with the tube segment 331 of the sealing plate 33, and abuts an outward surface of the bearing plate 32.

With reference to FIGS. 3, 6 and 11, an outer end of the connecting tube 34 is mounted in the tube segment 331 of the sealing plate 33. The connecting tube 34 and the tube segment 331 form the channel of the side assembly 30. A seal ring 37 is mounted between an outer surface of the connecting tube 34 and an inner surface of the tube segment 331 to provide a waterproof effect.

The stop cone 41 is hollow, is mounted on the side assembly 30 that is adjacent to the outlet port 22, abuts outward on the sealing plate 33 of the corresponding side assembly 30, is securely mounted around the clamping segment 335 of the sealing plate 33, and engages with the rotation-stopping segments 336 on the clamping segment 335. Thus, the stop cone 41 securely abuts the sealing plate 33, and relative shake and rotation between the stop cone 41 and the sealing plate 33 is reduced. The stop cone 41 has a stop flange 411 and multiple outer ribs 412. The stop flange 411 is transversely and annularly formed around an edge around an inward opening of the stop cone 41. The outer ribs 412 are formed on an outer surface of the stop cone 41, are annularly arranged spaced apart from one another, and extend to two axial sides of the stop cone 41, thereby strengthening the structure of the stop cone 41 to prevent the stop cone 41 from being broken easily and to prolong the lifespan of the tube assembly.

With reference to FIGS. 2 to 4, to mount the tube assembly as described, the filter cartridge 50 is mounted in the tube body 10. Centers of two ends of the filter cartridge 50 are respectively mounted around the connecting tubes 34 of the side assemblies 30. The filter cartridge 50 abuts the stop flange 411 of the stop cone 41. Two seal rings 38 are mounted between an inner surface of the filter cartridge 50 and the outer surface of the connecting tube 34 to provide a waterproof effect. A side plug 42 is mounted in the side assembly 30 that is adjacent to the inlet port 21, and is mounted in the tube segment 331 of the sealing plate 33 of the corresponding side assembly 30 to seal the channel of the corresponding side assembly 30.

When the tube assembly as described is in use, solution flows into the tube body 10 from the inlet port 21, and then flows into the filter cartridge 50 from one of the ends of the filter cartridge 50. Afterwards, the solution flows out of the filter cartridge 50 from the other end of the filter cartridge 50, and is divided into waste fluid and filtrate. The waste fluid flows out of the outlet port 22, and the filtrate flows out of the tube segment 331 of the sealing plate 33 of the side assembly 30 to be collected.

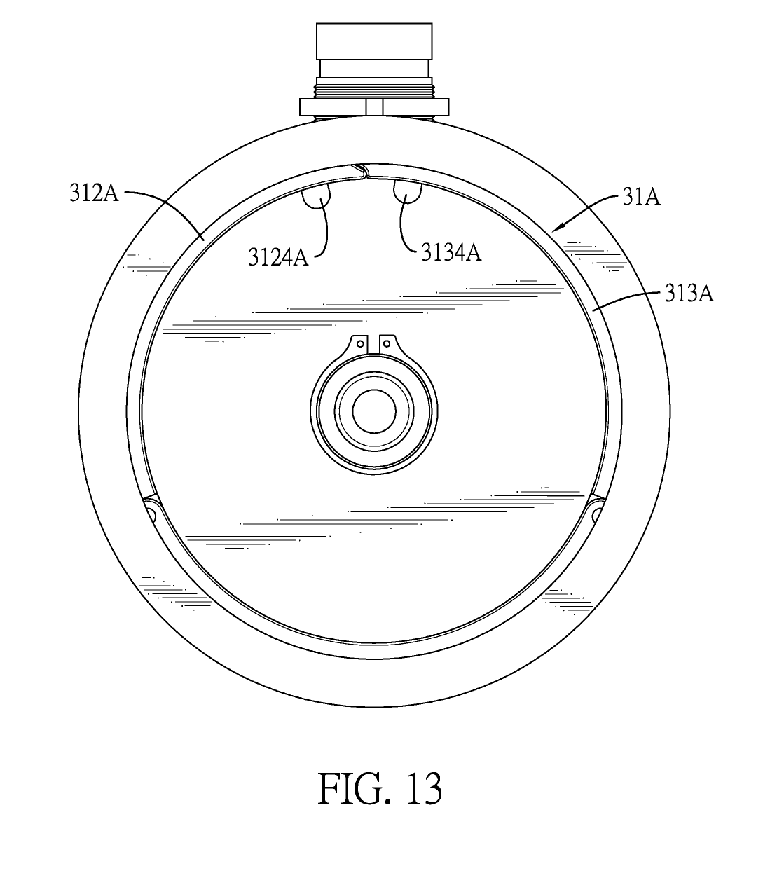

With reference to FIG. 13, in a second embodiment of the present invention, the second block segment 312A and the third block segment 313A of the block ring 31A may have no separating hole, and respectively have a wing 3124A, 3134A instead. The wing 3124A is transversely and inwardly formed on the second block segment 312A, and is disposed adjacent to the outer end of the second block segment 312A. The wing 3134A is transversely and inwardly formed on the third block segment 313A, and is disposed adjacent to the outer end of the third block segment 313A. Thus, to disassemble the block ring 31A from the tube body, the user just has to grip one of the wings 3124A, 3134A to push the second block segment 312A or the third segment 313A, which can also conveniently disassemble the block ring 31A.

In another embodiment, the amount of the block segments of the block ring may be altered into other numbers, such as two while also achieving the objective of the present invention.

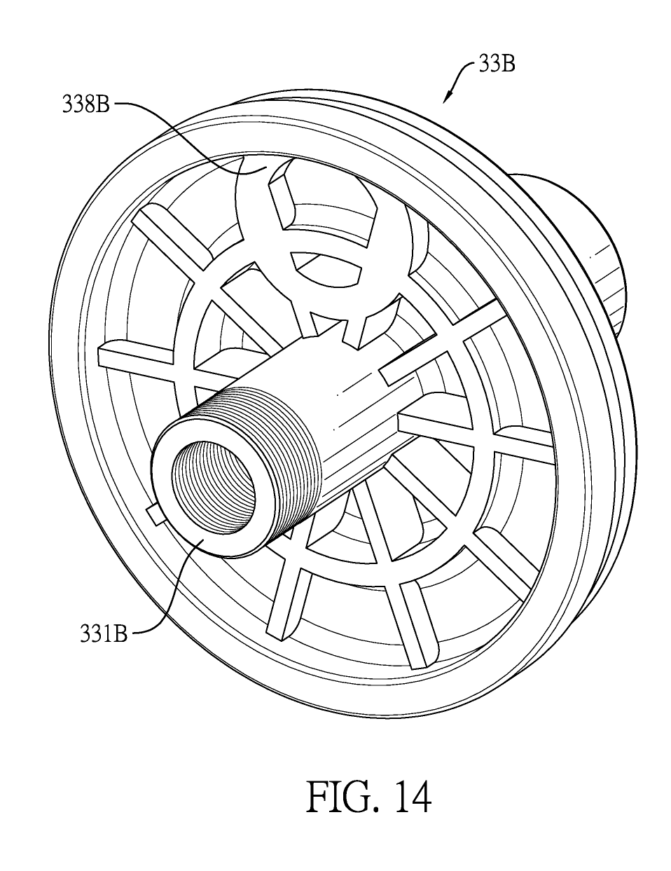

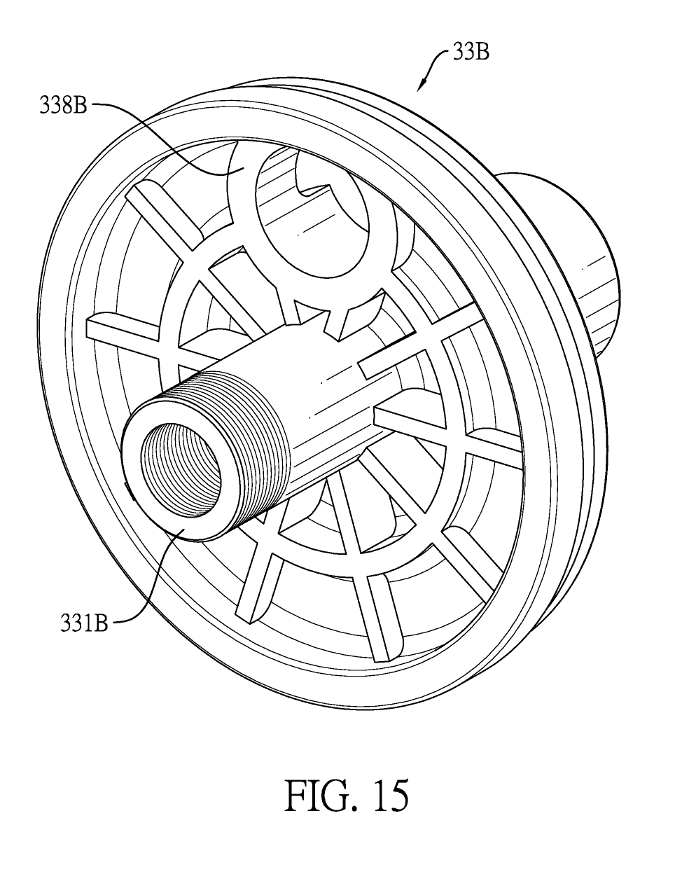

With reference to FIG. 14, in a third embodiment of the present invention, the sealing plate 33B further has a reserved hole annular flange 338B. The reserved hole annular flange 338B is formed on the outward surface of the sealing plate 33B, and is disposed transversely next to the tube segment 331B. With reference to FIG. 15, the inlet port or the outlet port may not be mounted on the tube body. A through hole is drilled in the reserved hole annular flange 338B of the sealing plate 33B, and another through hole is drilled on the bearing plate at a position corresponding to the reserved hole annular flange 338B, and then the user can mount the inlet port or the outlet port through the reserved hole annular flange 338B of the sealing plate 33B and the bearing plate. At this time, the reserved hole annular flange 338B is mounted around the inlet port or the outlet port, thereby strengthening the structure.

In another embodiment, the sealing plate may have no annular rib, no transverse rib and no reserved hole annular flange; that is, a plane is disposed between the tube segment and the bearing flange.

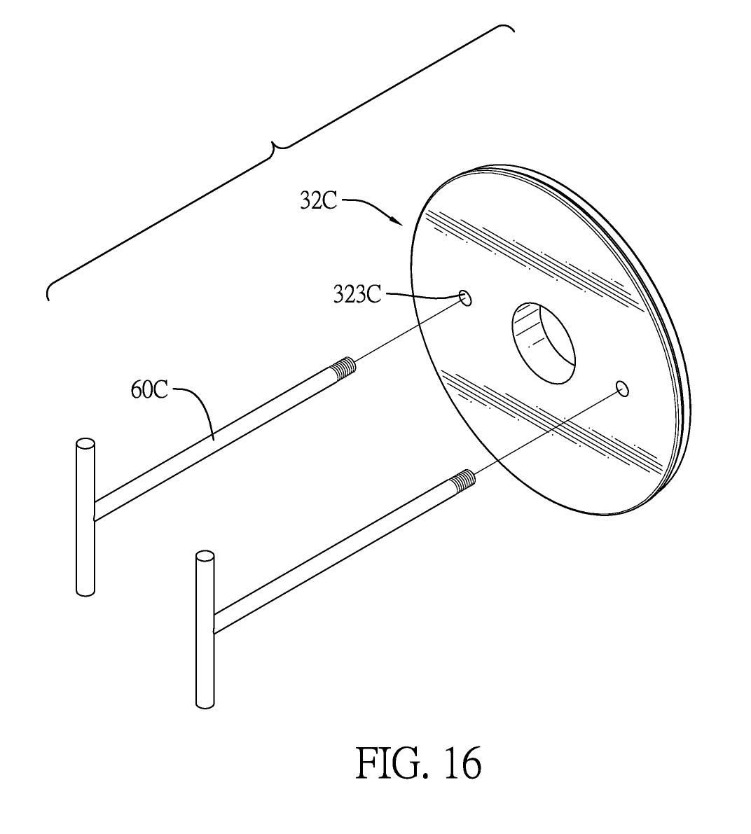

With reference to FIG. 16, in a fourth embodiment of the present invention, the bearing plate 32C may have two screw holes 323C axially formed through the bearing plate 32C. Thus, after the block ring is disassembled, the user can screw two T handle thread shafts 60C respectively into the screw holes 323C. Then, the user can conveniently pull out the bearing plate 32C by the T handle screwdrivers 60C.

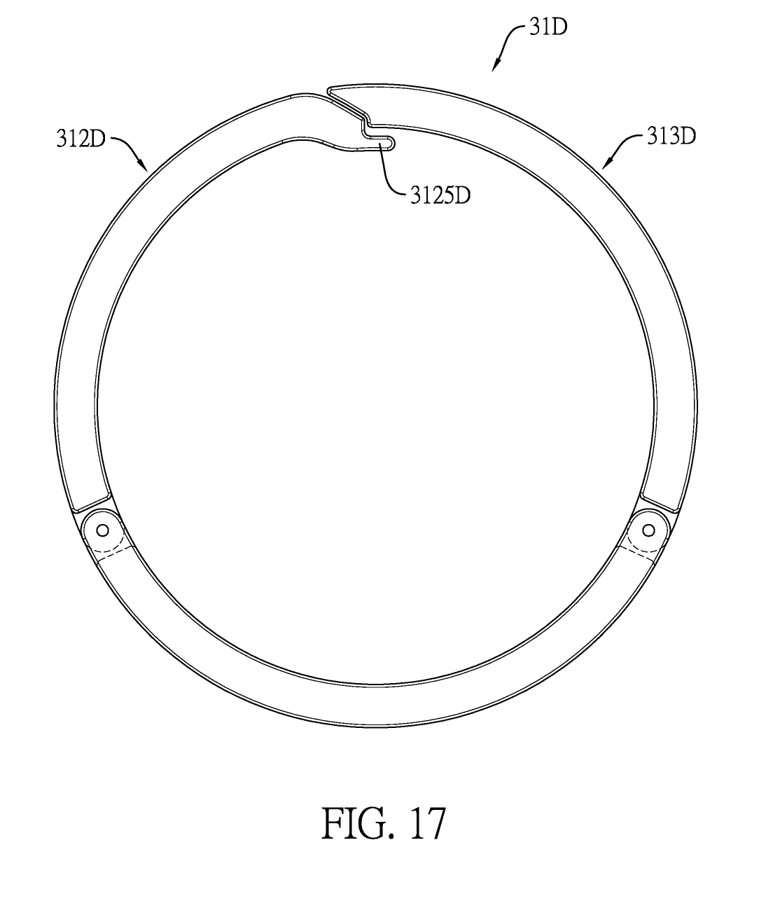

With reference to FIG. 17, in a fifth embodiment of the present invention, the second block segment 312D and the third block segment 313D of the block ring 31D may have no separating hole, and the second block segment 312D further has an extending segment 3125D instead. The extending segment 3125D is transversely and inwardly formed on the second block segment 312D, is disposed adjacent to the outer end of the second block segment 312D, and extends to a transverse inner side of the third block segment 313D. Thus, to disassemble the block ring 31D from the tube body, the user just has to insert an ordinary flat blade screwdriver between the extending segment 3125D and the transverse inner side of the third block segment 313D, and then push the flat blade screwdriver transversely and inwardly, which transversely and inwardly moves the second block segment 312D. At this time, the second block segment 312D and third block segment 313D do not abut each other, and the user can easily remove the block ring 31D. Consequently, the block ring 31D is easily to be disassembled only by a common tool.

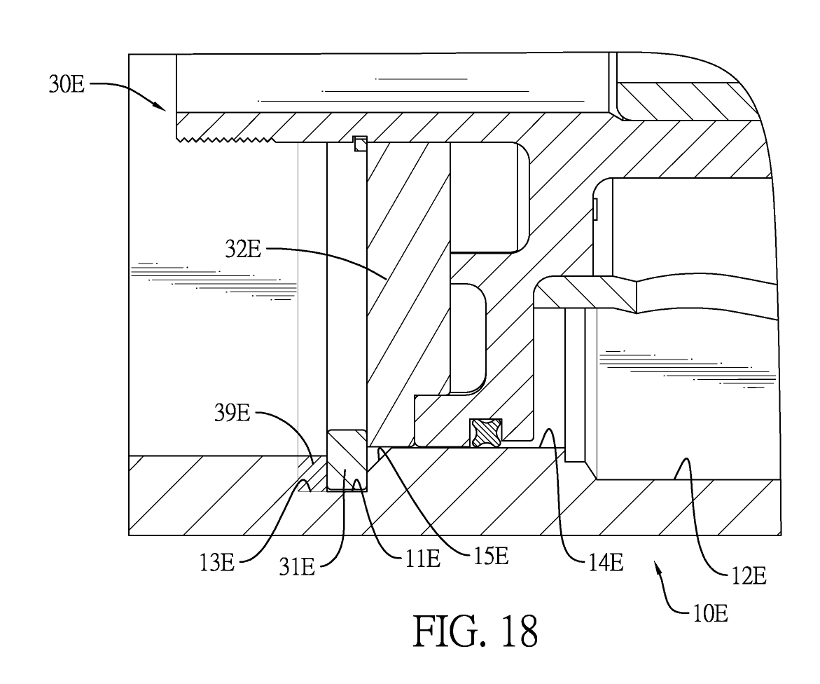

With reference to FIG. 18, in a sixth embodiment of the present invention, the tube body 10E further has two abutting annular grooves 13E. The abutting annular grooves 13E are formed in the inner surface of the tube body 10E, are respectively disposed in an axial outer side relative to the outer annular grooves 11E, and respectively communicate with the outer annular grooves 11E. Each side assembly 30E further has an abutting ring 39E. The abutting ring 39E is preferably made of metal, is mounted in the corresponding abutting annular groove 13E, and axially and inwardly abuts the corresponding block ring 31E to further support the block ring 31E, since the structural strength of joints between any two adjacent block segments are relatively weak. An inner diameter of the abutting ring 39E is equal to an inner diameter of the tube body 10E, and the block ring 31E can pass through the abutting ring 39E when not formed into a loop yet.

The abutting ring 39E may be a full-circular solid ring, and is wrapped in the tube body 10E when the tube body 10E is wound by filament winding.

In addition, the abutting ring may be a strip wound spirally and axially overlaps itself to become a spiral gradually when moving along the abutting annular grooves. The pushing of the abutting ring is not stopped until the abutting ring is completely inserted into the abutting annular groove. In this case, the abutting ring is mounted in the tube body after the tube body is wound by filament winding.

The tube body 10E further has two abutting segments 14E. Each abutting segment 14E is formed in the inner surface of the tube body 10E, and is disposed between one of the inner annular grooves 12E and the corresponding outer annular groove 11E. The bearing plate 32E of each side assembly 30E transversely abuts one of the abutting segments 14E, such that the tube body 10E transversely and firmly supports the bearing plates 32E.

The tube body 10E further has two sloped annular grooves 15E. Each sloped annular groove 15E is formed in the inner surface of the tube body 10E, and is formed on an axial outer periphery of one of the abutting segments 14E. An inner diameter of the sloped annular groove 15E is gradually decreased axially and inwardly, thereby guiding the bearing plate 32E into the abutting segment 14E when the bearing plate 32E is assembled into the tube body 10E.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tube assembly for a reverse osmosis filter cartridge, the tube assembly comprising:
a tube body having
an inner space;
two openings respectively formed on two sides of the tube body; and
two outer annular grooves formed in an inner surface of the tube body and being respectively adjacent to the openings of the tube body;
an inlet port mounted through the tube body and protruding out of the tube body;
an outlet port mounted through the tube body and protruding out of the tube body;
two side assemblies mounted in the tube body, and being respectively adjacent to the openings of the tube body; the side assemblies sealing the openings of the tube body, and each of the side assemblies having a channel communicating with the inner space of the tube body and an exterior environment; each of the side assemblies further having
a block ring engaging with the outer annular groove of the tube body;
a bearing plate abutting outward on the block ring;
a sealing plate abutting outward on the bearing plate and having
a tube segment axially formed on a center of the sealing plate, mounted through and protruding out of the bearing plate;
a clamping segment formed on an inward surface of the sealing plate, and formed annularly around the tube segment; and
at least one rotation-stopping segment formed transversely on the clamping segment of the sealing plate; and
a connecting tube mounted in the tube segment of the sealing plate; the connecting tube and the tube segment forming the channel of the side assembly; and
a stop cone mounted on the side assembly that is adjacent to the outlet port, abutting outward on the sealing plate of the side assembly that is adjacent to the outlet port, securely mounted around the clamping segment of the sealing plate, and engaging with the at least one rotation-stopping segment.

2. The tube assembly for a reverse osmosis filter cartridge as claimed in claim 1, wherein each one of the at least one rotation-stopping segment of each of the side assemblies is a protrusion, and connects to the inward surface of the sealing plate.

3. The tube assembly for a reverse osmosis filter cartridge as claimed in claim 1, wherein the stop cone has multiple outer ribs formed on an outer surface of the stop cone and extending to two axial sides of the stop cone.

4. The tube assembly for a reverse osmosis filter cartridge as claimed in claim 1, wherein
the bearing plate of each of the side assemblies has
a clamping segment formed on an inward surface of the bearing plate; and
the sealing plate of each of the side assemblies has
a bearing flange formed on an outward surface of the sealing plate, formed annularly around a periphery of the sealing plate, abutting outward on the bearing plate, and securely mounted around the clamping segment of the bearing plate; and
an annular rib formed on the outward surface of the sealing plate, and abutting outward on the clamping segment of the bearing plate.

5. The tube assembly for a reverse osmosis filter cartridge as claimed in claim 4, wherein the sealing plate of each of the side assemblies has
multiple transverse ribs formed on the outward surface of the sealing plate, extending transversely from the tube segment, connecting to the annular rib and the bearing flange, and abutting outward on the clamping segment of the bearing plate.

6. The tube assembly for a reverse osmosis filter cartridge as claimed in claim 1, wherein the sealing plate of each of the side assemblies has
a reserved hole annular flange formed on an outward surface of the sealing plate, and disposed transversely next to the tube segment.

7. The tube assembly for a reverse osmosis filter cartridge as claimed in claim 1, wherein the bearing plate of each of the side assemblies has at least one screw hole.

8. The tube assembly for a reverse osmosis filter cartridge as claimed in claim 1, wherein the block ring of each of the side assemblies has
multiple block segments connected to each other into a loop; any two adjacent ones of the block segments pivotally connected to each other, and outer ends of two of the block segments detachably abutting each other.

9. The tube assembly for a reverse osmosis filter cartridge as claimed in claim 8, wherein in the block ring of each of the side assemblies, each of the two block segments that detachably abut each other has
a separating hole formed in the block segment, and disposed adjacent to the outer end of the block segment.

10. The tube assembly for a reverse osmosis filter cartridge as claimed in claim 8, wherein in the block ring of each of the side assemblies, each of the two block segments that detachably abut each other has
a wing transversely and inwardly formed on the block segment, and disposed adjacent to the outer end of the block segment.

11. The tube assembly for a reverse osmosis filter cartridge as claimed in claim 8, wherein in the block ring of each of the side assemblies, one of the two block segments that detachably abut each other has
an extending segment transversely and inwardly formed on said block segment, disposed adjacent to the outer end of said block segment, and extending to a transverse inner side of the other block segment of said two block segments.

12. The tube assembly for a reverse osmosis filter cartridge as claimed in claim 8, wherein an amount of the block segments of the block ring of each of the side assemblies is three, and the block segments respectively are a first block segment, a second block segment, and a third block segment; two ends of the first block segment are respectively pivotally connected to an inner end of the second block segment and an inner end of the third block segment; an outer end of the second block segment and an outer end of the third block segment detachably abut each other.

13. The tube assembly for a reverse osmosis filter cartridge as claimed in claim 8, wherein in the block ring of each of the side assemblies,
one of the two block segments that detachably abut each other has
an abutting protrusion formed on the outer end of said one of the two block segments, and being inclined transversely; and
the other block segment of the two block segments that detachably abut each other has
an abutting recess formed in the outer end of said the other block segment, being inclined transversely, and the abutting protrusion selectively abutting the abutting recess.

14. The tube assembly for a reverse osmosis filter cartridge as claimed in claim 12, wherein in the block ring of each of the side assemblies,
the second block segment has
an abutting protrusion formed on the outer end of the second block segment, and being inclined transversely; and
the third block segment has
an abutting recess formed in the outer end of the third block segment, being inclined transversely, and the abutting protrusion selectively abutting the abutting recess.

15. The tube assembly for a reverse osmosis filter cartridge as claimed in claim 8, wherein
the tube body further has
two abutting annular grooves formed in the inner surface of the tube body, respectively disposed in an axial outer side relative to the outer annular grooves, and respectively communicating with the outer annular grooves;
each side assembly further has
an abutting ring made of metal, mounted in the corresponding abutting annular groove, and axially and inwardly abutting the corresponding block ring; an inner diameter of the abutting ring is equal to an inner diameter of the tube body.

16. The tube assembly for a reverse osmosis filter cartridge as claimed in claim 14, wherein
the tube body further has
two abutting annular grooves formed in the inner surface of the tube body, respectively disposed in an axial outer side relative to the outer annular grooves, and respectively communicating with the outer annular grooves;
each side assembly further has
an abutting ring made of metal, mounted in the corresponding abutting annular groove, and axially and inwardly abutting the corresponding block ring; an inner diameter of the abutting ring is equal to an inner diameter of the tube body.

17. The tube assembly for a reverse osmosis filter cartridge as claimed in claim 1, wherein
the tube body further has
two abutting segments formed in the inner surface of the tube body; each abutting segment disposed between one of the inner annular grooves and the corresponding outer annular groove; and
the bearing plate of each side assembly transversely abuts one of the abutting segments.

18. The tube assembly for a reverse osmosis filter cartridge as claimed in claim 16, wherein
the tube body further has
two abutting segments formed in the inner surface of the tube body; each abutting segment disposed between one of the inner annular grooves and the corresponding outer annular groove; and
the bearing plate of each side assembly transversely abuts one of the abutting segments.

19. The tube assembly for a reverse osmosis filter cartridge as claimed in claim 17, wherein
the tube body further has
two sloped annular grooves formed in the inner surface of the tube body; each sloped annular groove formed on an axial outer periphery of one of the abutting segments; an inner diameter of the sloped annular groove being gradually decreased axially and inwardly.

20. The tube assembly for a reverse osmosis filter cartridge as claimed in claim 18, wherein
the tube body further has
two sloped annular grooves formed in the inner surface of the tube body; each sloped annular groove formed on an axial outer periphery of one of the abutting segments; an inner diameter of the sloped annular groove being gradually decreased axially and inwardly.
